(19) United States
(12) Patent Application Publication
(10) Pub. No.: US 2025/0334679 A1
(43) Pub. Date: Oct. 30, 2025

(54) MEASUREMENT DEVICE AND MEASUREMENT METHOD

(71) Applicant: Panasonic Intellectual Property Management Co., Ltd., Osaka (JP)

(72) Inventors: TASUKU NAKAMURA, Osaka (JP); SHINYA OKAMOTO, Kyoto (JP); KATSUYA NOZAWA, Osaka (JP); YASUHISA INADA, Osaka (JP); KAZUYA HISADA, Nara (JP)

(21) Appl. No.: 19/260,694

(22) Filed: Jul. 7, 2025

Related U.S. Application Data
(63) Continuation of application No. PCT/JP2023/046352, filed on Dec. 25, 2023.

(30) Foreign Application Priority Data
Jan. 27, 2023 (JP) 2023-010992

(51) Int. Cl. G01S 7/4861; G01S 7/481; G01S 7/4865; G01S 17/10

(52) U.S. Cl. CPC G01S 7/4861; G01S 7/4814; G01S 7/4865; G01S 17/10

(57) ABSTRACT

A measurement device includes: a first light source that repeatedly emits first pulsed light; a first photodetector that detects reflected pulsed light that is generated when the first pulsed light is reflected by an object and outputs a first electric signal in accordance with a detection result of the reflected pulsed light; a signal processing circuit that calculates a distance from the measurement device to the object based on the first electric signal in a sampling period; and a control circuit that controls a driver that varies an optical path length from the first light source to the first photodetector via the object. The control circuit changes a position of a peak of the reflected pulsed light in the first electric signal in the sampling period by controlling the driver. The sampling period is synchronized with a timing at which the first light source emits the first pulsed light.

### BACKGROUND

### 1. Technical Field

The present disclosure relates to a measurement device and a measurement method.

### 2. Description of the Related Art

An optical frequency comb laser is a laser light source that emits laser light whose pulse waveforms are equally spaced on the time axis and whose spectra are equally spaced on the frequency axis. Hereafter, an optical frequency comb laser will be referred to as an optical comb laser.

Regarding an optical comb laser, two parameters are important. One is “repetition frequency” (fᵣₑₚ) that represents the spectral spacing. Another is “carrier envelope offset frequency” (f_{CEO}) that represents a residue when the spectrum is extrapolated to 0. These parameters change slightly due to disturbances such as vibration and temperature. However, it is possible to stabilize the parameters by incorporating a modulation device, such as a Peltier element or a piezoelectric element, in the optical comb laser. Thus, it is possible to realize precise measurement.

Dual comb refers to a method of performing measurement by preparing two optical comb lasers whose repetition frequencies slightly differ from each other and by causing laser beams emitted from these to interfere with each other.

With dual comb, a beat is generated when two laser beams whose repetition frequencies are fᵣₑₚ and fᵣₑₚ+δfᵣₑₚ interfere with each other. As a result, it is possible to acquire a spectrum with spacing δfᵣₑₚ. Here, it is important that the spectrum of a laser beam after interference is in the megahertz band, which is a radio frequency band, while the spectrum of a laser beam before interference is in the terahertz band.

Existing detectors, whose response frequency is in the gigahertz band or lower, cannot physically detect a signal of light in the terahertz band. Therefore, with existing technology, it is not possible to directly use a detector to examine the wavelength of light, and a detector is used after splitting light by wavelength by using a spectroscope. Thus, existing technology has a problem in that it takes time to sweep wavelength and it is not possible to perform spectral measurement in a short time.

However, with dual comb, it is possible to down-convert light into the megahertz band. Therefore, dual comb has an advantage that it is not necessary to use a spectroscope and it is possible to perform spectrum measurement at a high speed compared with existing technology. In addition, since information of light can be directly measured, it is possible to realize high-sensitivity and high-accuracy measurement. Thus, dual comb has been increasingly used for various measurements such as spectrometry, distance measurement, and frequency measurement (see, for example, Zebin Zhu, Wu Guanhao, “Dual-comb ranging” Engineering, Vol. 4, Issue 6, December 2018, pp. 772-778).

### SUMMARY

In one general aspect, the techniques disclosed here feature a measurement device including: a first light source that repeatedly emits first pulsed light; a first photodetector that detects reflected pulsed light that is generated when the first pulsed light is reflected by an object and that outputs a first electric signal in accordance with a detection result of the reflected pulsed light; a signal processing circuit that calculates a distance from the measurement device to the object based on the first electric signal in a sampling period; and a control circuit that controls a driver that varies an optical path length from the first light source to the first photodetector via the object. The control circuit changes a position of a peak of the reflected pulsed light in the first electric signal in the sampling period by controlling the driver. The sampling period is synchronized with a timing at which the first light source emits the first pulsed light.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A schematically illustrates an example of the time variation of the electric field of optical comb laser light;

FIG. 1B schematically illustrates an example of the frequency spectrum of optical comb laser light;

FIG. 2 schematically illustrates an example of the frequency spectrum of first optical comb laser light and an example the frequency spectrum of second optical comb laser light in dual comb;

FIG. 3 schematically illustrates a time waveform that is acquired as a result of interference of optical comb laser beams for each of light on the reference side and light on the object side in dual comb;

FIG. 4 schematically illustrates a phase spectrum after interference in dual comb;

FIG. 5 schematically illustrates the relationship between the position of a pulse waveform after interference and a measurement result in a sampling period;

FIG. 6A schematically illustrates a measurement device according to a first embodiment;

FIG. 6B schematically illustrates a measurement device according to a second embodiment;

FIG. 6C schematically illustrates a measurement device according to a third embodiment;

FIG. 7 is a flowchart illustrating a first example of the operation of a measurement device according to each embodiment;

FIG. 8 is a flowchart illustrating a second example of the operation of a measurement device according to each embodiment;

FIG. 9A is a flowchart illustrating an example of premeasurement in a third example of a measurement device according to each embodiment;

FIG. 9B is a flowchart illustrating an example of main measurement in the third example of a measurement device according to each embodiment; and

FIG. 10 is a flowchart illustrating an example of single-point measurement in a fourth example of a measurement device according to each embodiment.

### DETAILED DESCRIPTIONS

Improvement in accuracy is required not only for dual comb but also for distance measurement using pulsed light such as TOF (Time Of Flight).

The present disclosure provides a measurement device and a measurement method with which it is possible to measure a distance with high accuracy.

### Underlying Knowledge Forming Basis of the Present Disclosure

The inventors have found that the existing technology described in “Description of the Related Art” has the following problem.

In measurement using pulsed light, a sampling period for processing a signal is adjusted to the period of pulsed light. Therefore, the time waveform of an acquired signal corresponding to pulsed light may be distorted, depending on the timing of detecting the pulsed light, that is, the position of the pulsed light in the sampling period. In this case, the accuracy of a measurement result decreases as a result.

A technology that uses a phase spectrum instead of a time waveform is described in Zebin Zhu, Wu Guanhao, “Dual-comb ranging” Engineering, Vol. 4, Issue 6, December 2018, pp. 772-778. However, even when measurement is performed by using a phase spectrum, the accuracy of a measurement result may decrease, depending on the position of pulsed light in the sampling period.

One non-limiting and exemplary embodiment provides a measurement device and a measurement method with which it is possible to measure a distance with high accuracy.

According to a first aspect of the present disclosure, a measurement device includes: a first light source that repeatedly emits first pulsed light; a first photodetector that detects reflected pulsed light that is generated when the first pulsed light is reflected by an object and that outputs a first electric signal in accordance with a detection result of the reflected pulsed light; a signal processing circuit that calculates a distance from the measurement device to the object based on the first electric signal in a sampling period; and a control circuit that controls a driver that varies an optical path length from the first light source to the first photodetector via the object. The control circuit changes a position of a peak of the reflected pulsed light in the first electric signal in the sampling period by controlling the driver. The sampling period is synchronized with a timing at which the first light source emits the first pulsed light.

Thus, since it is possible to change the position of the peak of reflected pulsed light in the sampling period by controlling the driver, it is possible to displace the timing of detecting the reflected pulsed light from a range that may decrease the measurement accuracy in the sampling period. Therefore, with the measurement device according to the present aspect, it is possible to measure the distance with high accuracy.

According to a second aspect of the present disclosure, for example, in the measurement device according to the first aspect, the first light source may be an optical comb laser.

Thus, it is possible to improve the accuracy in distance measurement and to shorten the time required for measurement.

According to a third aspect of the present disclosure, for example, the measurement device according to the second aspect may further include: a second light source that is an optical comb laser and that repeatedly emits second pulsed light; and a second photodetector that detects a part of the first pulsed light by causing the part of the first pulsed light to interfere with a first portion of the second pulsed light and that outputs a second electric signal in accordance with a detection result of the part of the first pulsed light. A repetition frequency of the second light source may differ from a repetition frequency of the first light source. The first photodetector may detect the reflected pulsed light by causing the reflected pulsed light to interfere with a second portion of the second pulsed light, the second portion being different from the first portion. The signal processing circuit may calculate the distance based on the first electric signal and the second electric signal.

Thus, since measurement can be performed by using dual comb, it is possible to detect reflected pulsed light by using a general-purpose photodetector. It is possible to reduce the cost of a measurement device and to simplify the configuration of the measurement device.

According to a fourth aspect of the present disclosure, for example, in the measurement device according to any one of the first to third aspects, the signal processing circuit may calculate the distance based on a time waveform corresponding to the reflected pulsed light in the sampling period, and the control circuit may control the driver so that the position of the peak becomes closer to a center of the sampling period.

In measurement using time information, measurement accuracy tends to decrease in the vicinity of each of an initial portion and a terminal portion of a sampling period. With the present aspect, since the position of the peak of reflected pulse is made closer to the center of the sampling period, it is possible to suppress decrease of measurement accuracy.

According to a fifth aspect of the present disclosure, for example, in the measurement device according to any one of the first to third aspects, the signal processing circuit may calculate the distance based on a phase spectrum corresponding to the reflected pulsed light in the sampling period, and the control circuit may control the driver so that the position of the peak becomes farther from a center of the sampling period.

In measurement using phase information, measurement accuracy tends to decrease in the vicinity of the center of a sampling period. With the present aspect, since the position of the peak of the reflected pulse is made farther from the center of the sampling period, it is possible to suppress decrease of measurement accuracy.

According to a sixth aspect of the present disclosure, for example, in the measurement device according to any one of the first to fifth aspects, each time an irradiation point, which is a position on the object irradiated with the first pulsed light, moves, the control circuit may determine whether the optical path length needs to be changed, and, if the control circuit determines that the optical path length needs to be changed, the control circuit may vary the optical path length by controlling the driver.

Thus, since it is possible to vary the optical path length for each irradiation point, it is possible to suppress decrease of measurement accuracy.

According to a seventh aspect of the present disclosure, for example, in the measurement device according to any one of the first to sixth aspects, when the driver varies the optical path length, the signal processing circuit may correct the distance based on an amount of variation of the optical path length.

Thus, for example, since it is possible to correct the optical path length so as to reduce an offset that is added to a measurement result because the optical path length is varied, it is possible to increase the measurement accuracy.

According to an eighth aspect of the present disclosure, for example, in the measurement device according to the seventh aspect, the signal processing circuit may record the amount of variation of the optical path length when the driver varies the optical path length for each of a plurality of irradiation points, which are positions on the object irradiated with the first pulsed light, and the signal processing circuit may correct the distance for each of the plurality of irradiation points based on the amount of variation recorded by the signal processing circuit.

Thus, by recording the amount of variation for each irradiation point, it is possible to correct the distance of each irradiation point.

According to a ninth aspect of the present disclosure, for example, in the measurement device according to any one of the first to eighth aspects, the measurement device may perform main measurement of measuring the distance after performing premeasurement; in the premeasurement, the control circuit may determine an amount of variation of the optical path length at each of a plurality of irradiation points, which are positions on the object irradiated with the first pulsed light, based on the first electric signal that is obtained for each of the plurality of irradiation points; and, in the main measurement, the control circuit may control the driver in accordance with the amount of variation at each of the plurality of irradiation points.

Thus, for example, with the premeasurement, it is possible to acquire information about the amount of variation of the optical path length at all points beforehand. Therefore, for example, since it is possible to suppress a large change in the amount of variation when measurement is to be sequentially performed for a plurality of irradiation points, it is possible to increase the measurement accuracy.

According to a tenth aspect of the present disclosure, for example, in the measurement device according to any one of the first to ninth aspects, the control circuit may determine an amount of variation of the optical path length at each of a plurality of irradiation points including at least one irradiation point, which is a position on the object irradiated with the first pulsed light, based on the first electric signal obtained for the at least one irradiation point and information about a shape of the object, and the control circuit may control the driver in accordance with the amount of variation at each of the plurality of irradiation points.

Thus, by using the design data, it is possible to acquire information about the amount of variation of the optical path length at all points to be measured beforehand in a short time and with a small amount of calculation.

According to an eleventh aspect of the present disclosure, for example, the measurement device according to any one of the first to tenth aspects may further include the driver.

Thus, it is possible to realize an integrated measurement device including the driver. Since the amount of variation of the optical path length can be controlled with high accuracy, it is possible to increase the measurement accuracy.

According to a twelfth aspect of the present disclosure, a measurement method includes, for example: causing a light source to repeatedly emit pulsed light; causing a photodetector to detect reflected pulsed light that is generated when the pulsed light is reflected by an object and to output an electric signal in accordance with a detection result of the reflected pulsed light; causing a signal processing circuit to calculate a distance from the light source to the object based on the electric signal in a sampling period; and controlling a driver that varies an optical path length from the light source to the photodetector via the object. In the controlling, a position of a peak of the reflected pulsed light in the electric signal in the sampling period is changed by controlling the driver. The sampling period is synchronized with a timing at which the light source emits the pulsed light.

Thus, as with the measurement device described above, it is possible to measure the distance with high accuracy.

Hereafter, embodiments will be described in detail with reference to the drawings.

The embodiments described below each represent a general or specific example. The values, shapes, materials, elements, arrangements of elements, positions and connection configurations of elements, steps, order of steps, and the like described in the following embodiments are examples, and do not limit the present disclosure. Among the elements in the embodiments, elements that are not described in the independent claims are optional elements.

Each figure is schematic and is not necessarily drawn strictly. Accordingly, for example, the scales and the like do not necessarily coincide with each other between the figures. In the figures, substantially the same configurations are denoted by the same numerals, and redundant descriptions thereof will be omitted or simplified.

In the present specification, numerical ranges not only have strict meanings but also have meanings of substantially an equivalent range including, for example, a difference of about several percents.

In the present specification, unless otherwise noted, ordinal numbers, such as “first” and “second”, do not imply the number of elements or the order of elements, but are used in order to avoid confusion between similar elements and to discriminate between the elements.

### Optical Comb Laser

Before describing embodiments of the present disclosure, the fundamental principles of optical comb laser will be described briefly.

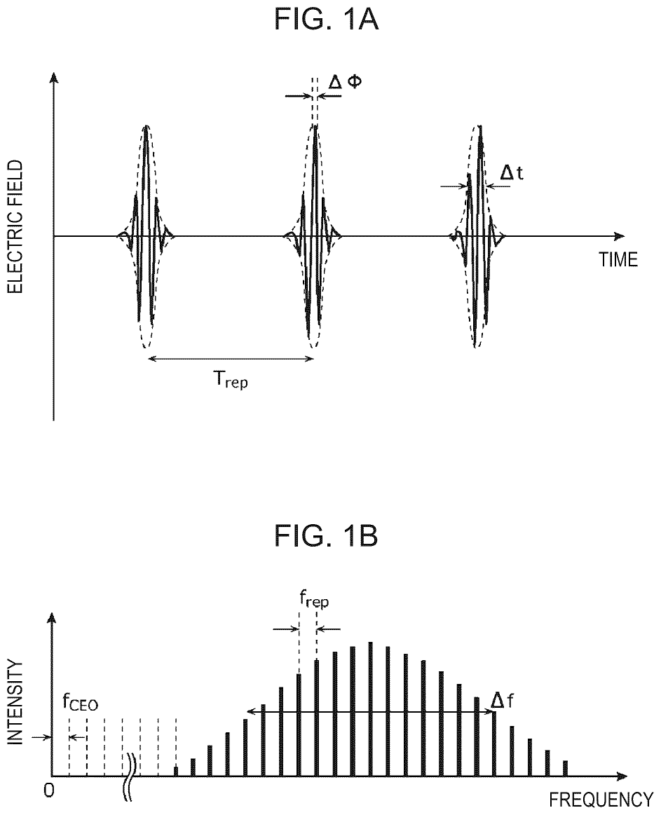

First, referring to FIGS. 1A and 1B, the time variation of the electric field and the frequency spectrum of optical comb laser light will be described.

FIG. 1A schematically illustrates an example of the time variation of the electric field of optical comb laser light. In FIG. 1A, the horizontal axis represents the time and the vertical axis represents the electric field of optical comb laser light. Optical comb laser light is also called optical frequency comb laser light. In the present specification, optical comb laser light may be simply referred to as laser light.

As illustrated in FIG. 1A, optical comb laser light is formed from a train of light pulses that are generated at a repetition period Tᵣₑₚ. The repetition period Tᵣₑₚ is, for example, greater than or equal to 100 ps and less than or equal to 100 ns. The full width at half maximum of each light pulse is denoted by Δt. The full width at half maximum At of each light pulse is, for example, greater than or equal to 10 fs and less than or equal to 100 ps.

In a laser resonator, the group velocity v_{g}, at which an envelope of a light pulse propagates, and the phase velocity vₚ, at which a wave in a light pulse propagates, have different values due to dispersion in the resonator or the like. Because of the difference between the group velocity v_{g} and the phase velocity vₚ, when two adjacent light pulses are superposed on each other so that the envelopes thereof coincide, the phases of waves in these light pulses shift by Δφ. Δφ has a value in the range of 0 to 2π. The repetition period of a light pulse train is represented by Tᵣₑₚ=L/v_{g}, where L is the round-trip length of the laser resonator.

FIG. 1B schematically illustrates an example of the frequency spectrum of optical comb laser light. In FIG. 1B, the horizontal axis represents the frequency and the vertical axis represents the intensity of optical comb laser light.

As illustrated in FIG. 1B, optical comb laser light has a comb-shaped frequency spectrum formed from a plurality of discrete equally spaced lines. The frequencies of the plurality of discrete equally spaced lines correspond to the longitudinal-mode resonant frequencies of the laser resonator. The repetition frequency fᵣₑₚ, which corresponds to the interval between two adjacent equally spaced lines of optical comb laser light, is represented by fᵣₑₚ=1/Tᵣₑₚ. The repetition frequency fᵣₑₚ is, for example, greater than or equal to 10 MHz and less than or equal to 1 THz. If the round-trip length of the laser resonator L is 30 cm and the group velocity v_{g} is approximately equal to the speed of light in vacuum (=3×10⁸ m/s), the repetition period Tᵣₑₚ is 1 ns and the repetition frequency fᵣₑₚ is 1 GHz.

When the full width at half maximum of optical comb laser light is denoted by Δf, Δf=1/Δt. The full width at half maximum Δf of optical comb laser light is, for example, greater than or equal to 10 GHz and less than or equal to 100 THz. When it is assumed that the equally spaced lines exist near the zero frequency, the frequency of an equally spaced line nearest to the zero frequency is called a carrier envelope offset frequency. The carrier envelope offset frequency f_{CEO} is represented by f_{CEO}=(Δφ/(2π))fᵣₑₚ. The carrier envelope offset frequency f_{CEO} has a value between 0 and the repetition frequency fᵣₑₚ. When the carrier envelope offset frequency f_{CEO} is defined as the 0-th mode, the n-th mode frequency fₙ of optical comb laser light is represented by fₙ=f_{CEO}+nfᵣₑₚ. The electric field E(t) of optical comb laser light illustrated in FIG. 1A is represented by E(t)=ΣₙEₙ exp[−i(2πfₙt+φₙ)], where Eₙ is the amplitude and φₙ is the phase of the electric field at the n-th mode frequency fₙ.

### Dual Comb

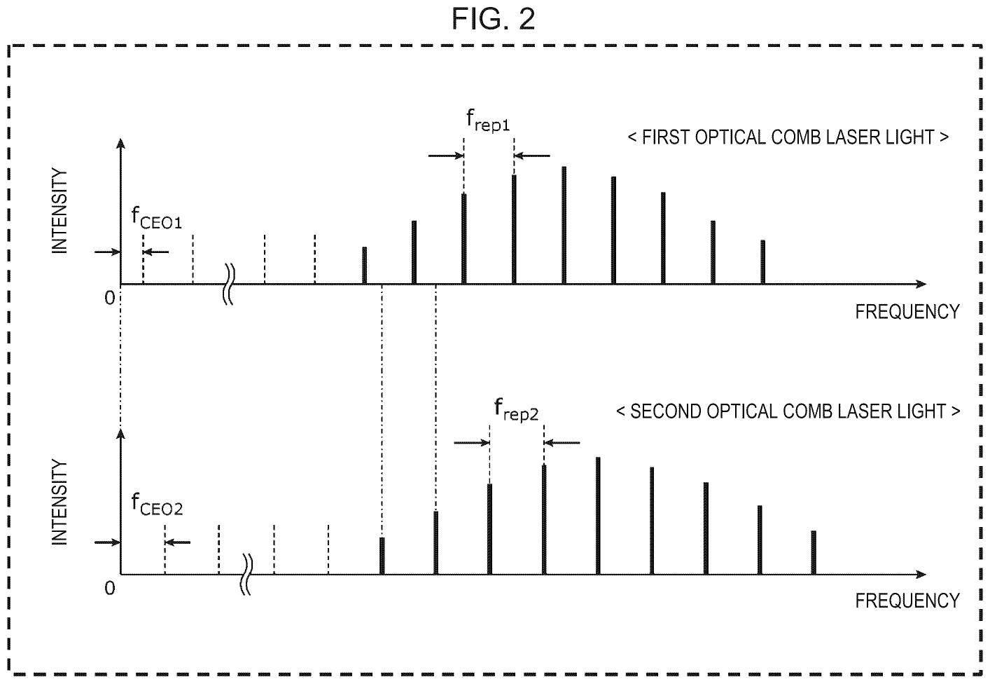

Next, referring to FIG. 2, the principles of dual comb will be described briefly.

FIG. 2 illustrates an example of the frequency spectrum of first optical comb laser light and an example the frequency spectrum of second optical comb laser light in dual comb. In FIG. 2, the horizontal axis represents the frequency, and the vertical axis represents the intensity of optical comb laser light.

Regarding the first optical comb laser light, the n-th mode frequency f₁ₙ is represented by f₁ₙ=f_{CEO1}+nfᵣₑₚ₁. Regarding the second optical comb laser light, the n-th mode frequency f₂ₙ is represented by f₂ₙ=f_{CEO2}+nfᵣₑₚ₂. f_{CEO1} and f_{CEO2} are respectively the carrier envelope offset frequencies of the first optical comb laser light and the second optical comb laser light. fᵣₑₚ₁ and fᵣₑₚ₂ are respectively the repetition frequencies of the first optical comb laser light and the second optical comb laser light. fᵣₑₚ₁ and fᵣₑₚ₂ differ from each other slightly. To be specific, a relationship fᵣₑₚ₂=fᵣₑₚ₁+δfᵣₑₚ holds. Here, δfᵣₑₚ is greater than 0 and far less than fᵣₑₚ₁. δfᵣₑₚ is, for example, greater than or equal to 1 Hz and less than or equal to 10 MHz.

Here, when f₁ᵢ is the i-th mode of the first optical comb laser light, f₁ᵢ=f_{CEO1}+ifᵣₑₚ₁ holds. It is assumed that the i-th mode f₂ᵢ of the second optical comb laser light is in the closest vicinity of the mode f₁ᵢ on the frequency axis. In this case, f₂ᵢ=f_{CEO2}+ifᵣₑₚ₂. When these two modes f₁ᵢ and f₂ᵢ interfere with each other, a difference frequency f₃ᵢ is generated. Here, f₃ᵢ=f₂ᵢ−f₁ᵢ=(f_{CEO2}−f_{CEO1})+(ifᵣₑₚ₂−ifᵣₑₚ₁)=δf_{CEO}+iδfᵣₑₚ holds. Note that it is regarded that δf_{CEO}=f_{CEO2}−f_{CEO1}. Since this is described in an expression similar to that of single optical comb laser light, a waveform obtained by interference of the first optical comb laser light and the second optical comb laser light is a pulse waveform similar to that of single optical comb laser. If δTᵣₑₚ=1/δfᵣₑₚ, the pulse period on the time axis is δTᵣₑₚ.

### Principles of Distance Measurement

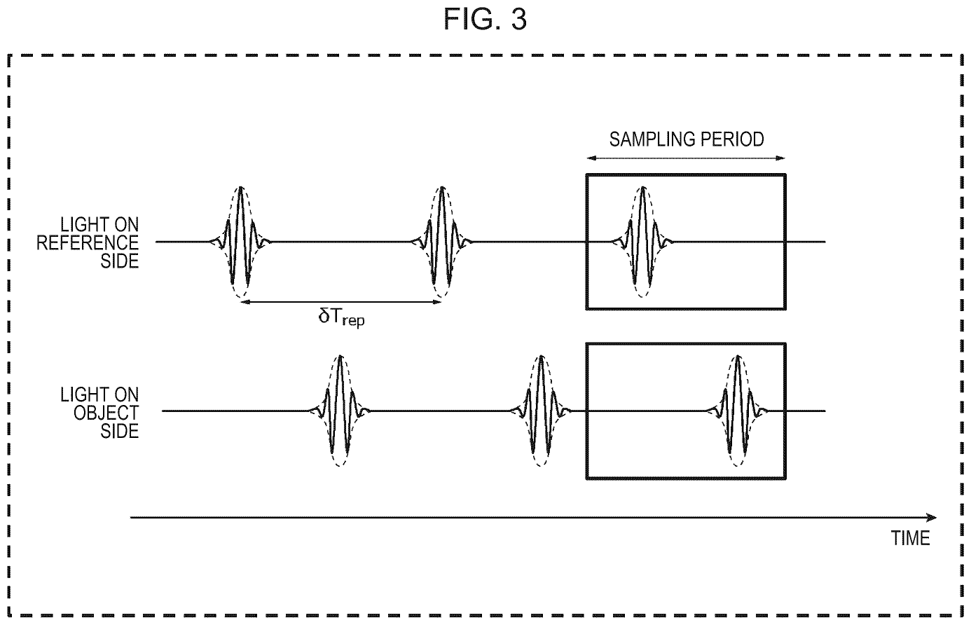

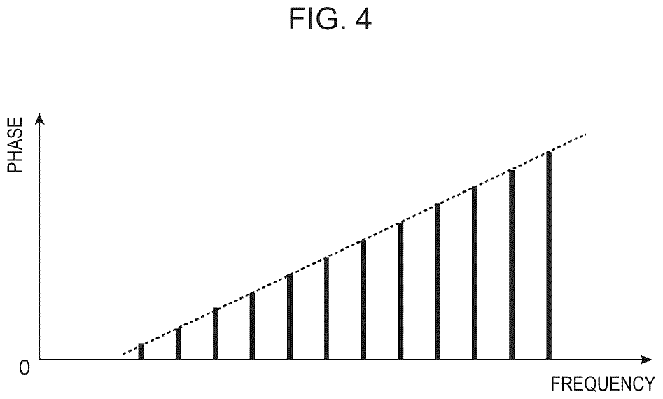

Next, referring to FIGS. 3 and 4, the principles of measurement of distance, that is, distance measurement using dual comb will be described.

FIG. 3 schematically illustrates a time waveform acquired as a result of interference of optical comb laser beams for each of light on the reference side and light on the object side in dual comb. In FIG. 3, the horizontal axis represents the time, and the vertical axis represents the electric field of optical comb laser light.

To perform distance measurement, for example, a light beam emitted from a light source is split into two light beams, one of the light beams is not emitted to an object, and the other light beam is emitted to the object. The light beam that is not emitted to the object and a light beam that is reflected by the object are individually received by detectors. Hereafter, the light beam that is not emitted to the object will be referred to as light on the reference side, and the light beam that is emitted to the object will be referred to as light on the object side.

In this case, as illustrated in FIG. 3, similar signal waveforms are obtained from the light on the reference side and the light on the object side. However, since the optical path length differs depending on whether or not the light has travelled via the object, the timing at which pulsed light is detected, that is, the position of the peak of pulsed light on the time axis is displaced as a result. The signal processor acquires a signal at a predetermined sampling period, calculates the displacement of the position of the peak of pulsed light, converts the displacement into a distance, thereby measuring the distance from the light source to the object.

The sampling period is a period that is synchronized with the timing at which the light source emits pulsed light. For example, in general, the length of the sampling period is the same as the pulse period. In the case of dual comb, it is possible to set a pulse period δTᵣₑₚ included in a signal after interference as the length of the sampling period.

Regarding distance measurement, there is a method using a phase spectrum instead of using the position of the peak of pulsed light on the time axis. That is, it is possible to perform distance measurement by using phase information instead of time information of pulsed light.

FIG. 4 schematically illustrates a phase spectrum after interference in dual comb. In FIG. 4, the horizontal axis represents the frequency, and the vertical axis represents the phase.

The phase spectrum can be obtained by Fourier-transforming a pulse waveform after interference. As illustrated in FIG. 4, it is possible to fit the phase spectrum to a straight line having a certain gradient. The gradient varies in proportion to the optical path length. Therefore, it is possible to measure the distance from the light source to the object from the difference between the gradient of reference optical comb laser light and the gradient of object optical comb laser light. In this way, it is possible measure the distance not only from the amount of displacement of the position of the peak of pulsed light but also from the phase information.

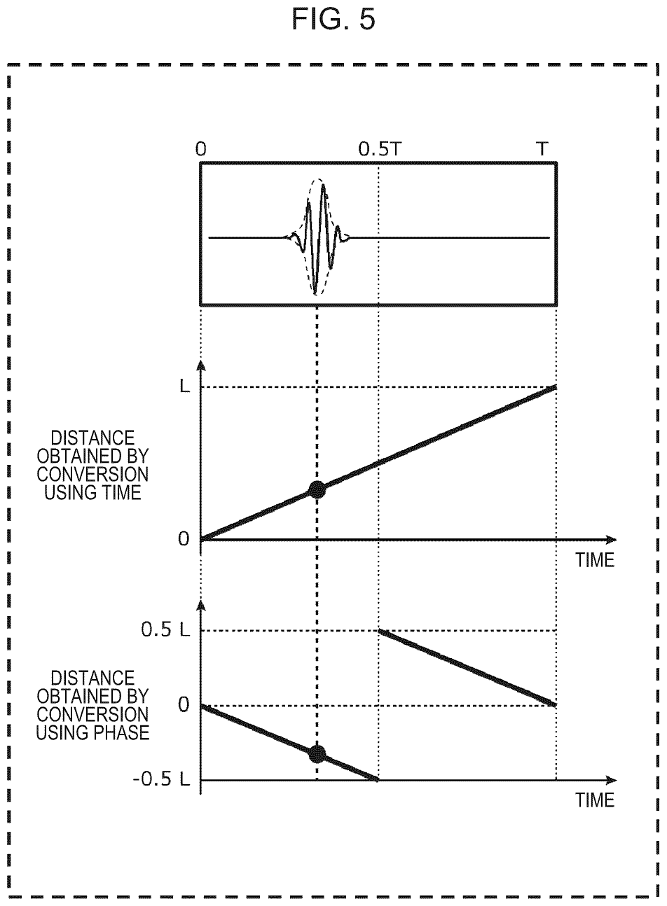

Here, referring to FIG. 5, a problem based on the positional relationship between a sampling period and a pulse waveform will be described.

FIG. 5 schematically illustrates the relationship between the position of a pulse waveform after interference and a measurement result in a sampling period. Here, the start of the sampling period is 0, and the end of the sampling period is T. The measured distance for the sampling period is L. Here, L corresponds to the aforementioned round-trip length of a pulse of the laser resonator. Since L corresponds the round-trip distance to the object, a value corresponding to L/2 is output as a measured value output from the measurement device.

When distance measurement is performed based on the position of the peak of pulsed light in a time waveform, if a pulse is present at the start or the end of a sampling period, due to the timing jitter of a light source and the resolution of a measuring instrument, the measured value of a distance may become close to 0 or close to L for each measurement. As a result, the accuracy of the measured value decreases.

When distance measurement is performed based on the phase spectrum, if a pulse is present at the center of a sampling period, for a similar reason, the measurement value of a distance for each pulse becomes close to −0.5L or close to 0.5L. As a result, the accuracy of the measured value decreases.

From the above facts, decrease of the accuracy of a measurement result occurs, depending on the position of the peak of pulsed light in a sampling period. The inventors have identified the problem and conceived a new measurement device and a new measurement method for solving this problem. Hereafter, embodiments of the present disclosure will be described.

### EMBODIMENTS

### First Embodiment

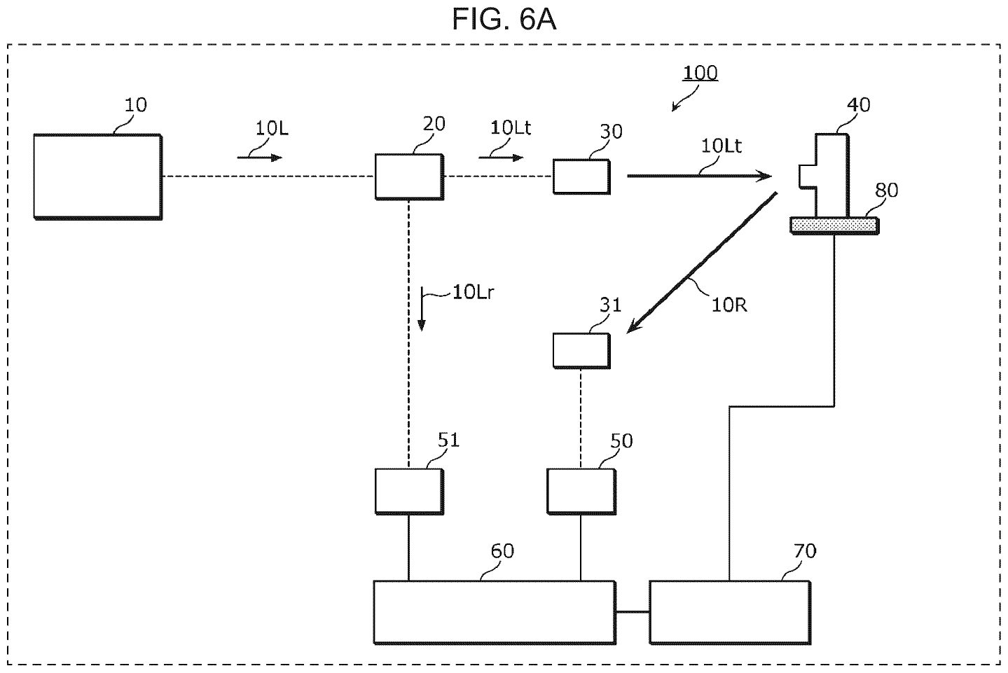

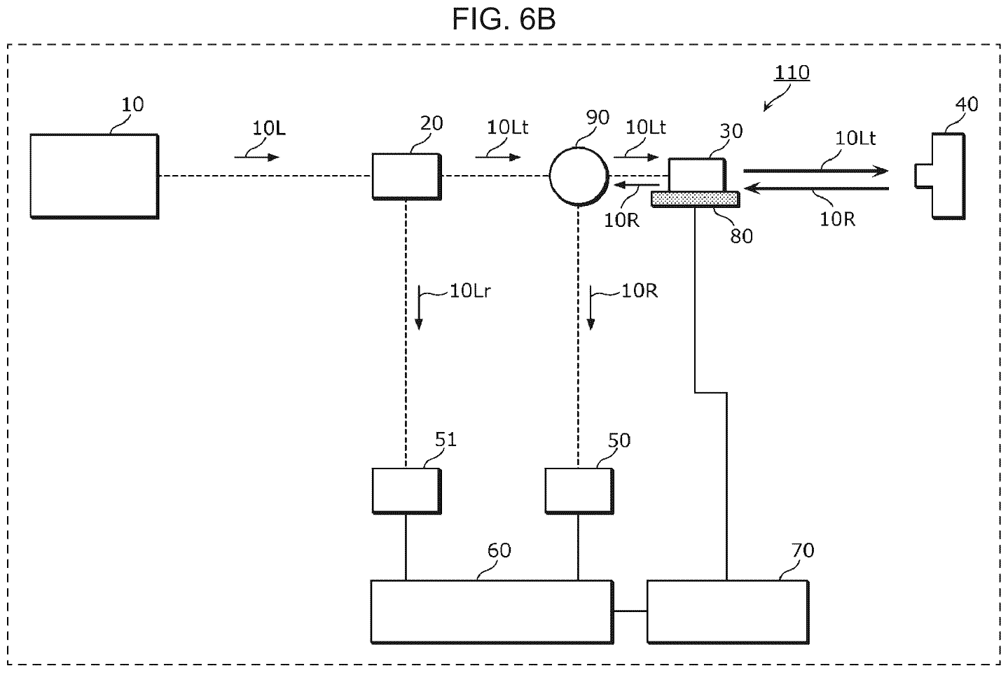

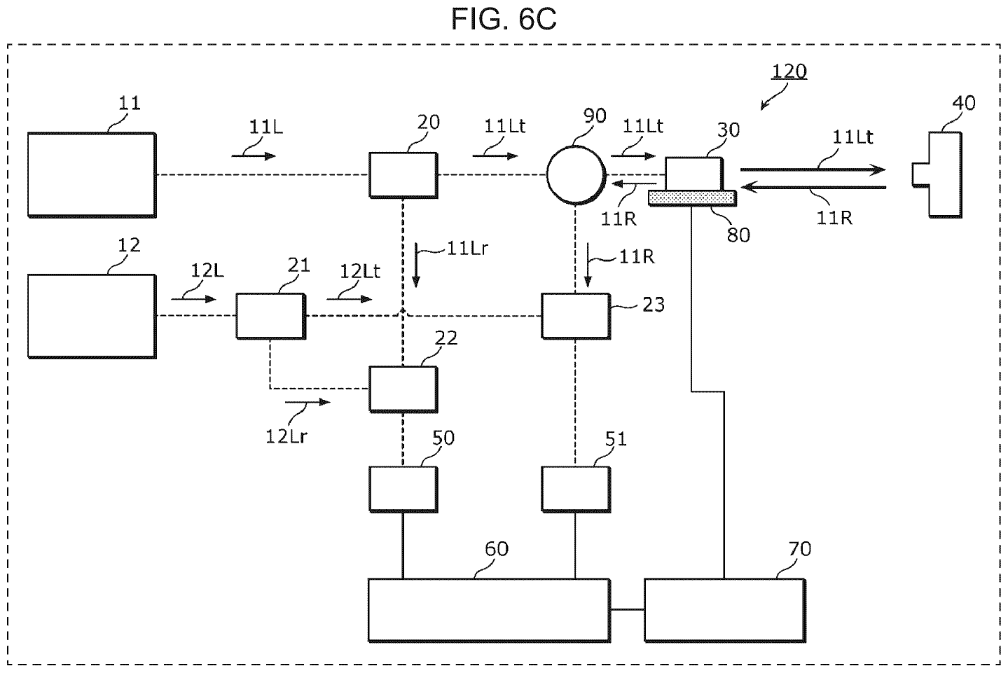

First, referring to FIG. 6A, the basic structure of a measurement device according to a first embodiment will be described. The measurement device according to the present embodiment is a device that performs dual-axis distance measurement. To be specific, the light-emitting axis of light emitted to an object and the light-receiving axis of reflected light from the object are different.

FIG. 6A schematically illustrates a measurement device 100 according to the present embodiment. The measurement device 100 illustrated in FIG. 6A measures the distance from the measurement device 100 to an object 40. For example, the measurement device 100 measures the distance from the measurement device 100 to each measurement point on the surface of the object 40. Thus, the measurement device 100 can obtain the surface shape of the object 40. The measurement point is the irradiation point of pulsed light.

The object 40 is, for example, a product, such as a screw, produced based on design data. However, the object 40 is not limited to this. The object 40 may be an industrial product, an agricultural product, or the like. It is possible to inspect the object 40 by measuring the surface shape of the object 40 by using the measurement device 100. Alternatively, the object 40 may be an animal such as a human. The object 40 is not limited to a solid, and may be a liquid, provided that the liquid can reflect pulsed light.

As illustrated in FIG. 6A, the measurement device 100 includes a pulsed light source 10, a coupler 20, optical heads 30 and 31, detectors 50 and 51, a signal processing circuit 60, a control circuit 70, and a driver 80. The elements of the measurement device 100 are connected by optical fibers shown by broken lines or by cables shown by solid lines. For example, optical elements such as the coupler 20, the optical heads 30 and 31, and the detectors 50 and 51 are disposed on the path of optical fibers. The pulsed light source 10 is connected to an end portion of an optical fiber. The detectors 50 and 51, the signal processing circuit 60, the control circuit 70, and the driver 80 are disposed on the path of cables.

The pulsed light source 10 is an example of a light source that repeatedly emits pulsed light. The pulsed light source 10 is, for example, an optical comb laser including a laser resonator. The pulsed light source 10 outputs light 10L as output light. The light 10L is, for example, optical comb laser light whose repetition frequency is fᵣₑₚ and carrier envelope offset frequency is f_{CEO}. As illustrated in FIG. 1A, optical comb laser light includes a plurality of pulsed light beams at regular time intervals. That is, the pulsed light source 10 repeatedly emits pulsed light by outputting optical comb laser light.

The coupler 20 is an optical element that splits light. To be specific, the coupler 20 splits the light 10L into signal light 10Lt and reference light 10Lr.

The optical head 30 is an optical element, such as a collimator, that makes light into collimated light and emits the light. To be specific, the optical head 30 converts the signal light 10Lt, which has been transmitted through an optical fiber, into collimated light and emits the collimated light toward the object 40. The optical head 30 may include an optical element, such as a lens, immediately after the collimator.

The optical head 31 is an optical element that receives light and guides the light to an optical fiber. To be specific, the optical head 31 receives reflected light 10R, which is generated when the emitted signal light 10Lt is reflected by the object 40, and guides the reflected light 10R to the optical fiber. As with the signal light 10Lt, the reflected light 10R includes a plurality of pulsed light beams. The plurality of pulsed light beams included in the reflected light 10R are reflected pulsed light beams that are generated when pulsed light beams included in the signal light 10Lt are reflected by the object 40.

The detectors 50 and 51 are each an optical element that generates an electric signal by performing photoelectric conversion on received light and outputs the electric signal. The signal level of the electric signal corresponds to the intensity of received light. The detectors 50 and 51 are each, for example, a photoelectric conversion element such as a photodiode or a phototransistor.

The detector 50 is an example of a first photodetector, detects a plurality of reflected pulsed light beams, and outputs a first electric signal in accordance with the detection result. To be specific, the detector 50 outputs the first electric signal by performing photoelectric conversion on the reflected light 10R received via the optical head 31 and the optical fiber.

The detector 51 is an example of a second photodetector, detects a part of pulsed light emitted by the pulsed light source 10, and outputs a second electric signal in accordance with a detection result. To be specific, the detector 51 outputs the second electric signal by performing photoelectric conversion on the reference light 10Lr split by the coupler 20.

The signal processing circuit 60 calculates the distance from the measurement device 100 to the object 40 based on the first electric signal. To be specific, the signal processing circuit 60 calculates the distance based on the first electric signal and the second electric signal. Specific examples of the calculation method include a method that uses time information and a method that uses phase information. For example, the signal processing circuit 60 calculates the distance based on a time waveform corresponding to reflected pulsed light in a sampling period. Alternatively, the signal processing circuit 60 may calculate the distance based on a phase spectrum corresponding to reflected pulsed light in a sampling period. Which of time information and phase information is to be used may be preset or may be switchable based on an instruction of a user or the like.

The control circuit 70 controls the driver 80. To be specific, the control circuit 70 controls the driver 80 in accordance with a timing at which reflected pulsed light is detected in a sampling period. The timing at which reflected pulsed light is detected is the position of the peak of reflected pulsed light on the time axis. Hereafter, the timing at which reflected pulsed light is detected may be referred to as “pulse position”.

In the present embodiment, the control circuit 70 changes the control of the driver 80 in accordance with a method with which the signal processing circuit 60 calculates the distance. For example, when the signal processing circuit 60 uses time information, the control circuit 70 controls the driver 80 so that the pulse position, which is the position of the peak of pulsed light, becomes closer to the center of a sampling period. To be specific, when the signal processing circuit 60 uses time information, the control circuit 70 controls the driver 80 so that the pulse position does not become an end of the sampling period, for example, so that the pulse position does not fall within neither of the range of greater than or equal to 0 and less than 0.05T and the range of greater than 0.95T and less than or equal to T. In other words, the control circuit 70 controls the driver 80 so that the pulse position falls within the range of greater than or equal to 0.05T and less than or equal to 0.95T. Here, T is the length of the sampling period, as illustrated in FIG. 5.

When the signal processing circuit 60 uses phase information, the control circuit 70 controls the driver 80 so that the pulse position becomes farther from the center of the sampling period. To be specific, when the signal processing circuit 60 uses phase information, the control circuit 70 controls the driver 80 so that the pulse position does not fall within a central range of the sampling period, for example, does not fall within the range of greater than 0.45T and less than 0.55T. In other words, the control circuit 70 controls the driver 80 so that the pulse position falls within the range of greater than or equal to 0 and less than or equal to 0.45T or the range of greater than or equal to 0.55T and less than or equal to T.

The signal processing circuit 60 and the control circuit 70 are each implemented, for example, in an LSI (Large Scale Integration), which is an IC (Integrated Circuit). The integrated circuit need not be an LSI, and may be a dedicated circuit or a general-purpose processor. For example, the signal processing circuit 60 and the control circuit 70 each may be a microcontroller. The microcontroller includes, for example, a non-volatile memory storing a program, a volatile memory that is a temporary storage area for executing a program, an input/output port, a processor that executes a program, and the like. The signal processing circuit 60 and the control circuit 70 each may be an FPGA (Field Programmable Gate Array), which is programmable, or a reconfigurable processor that allows reconfiguration of connection and setting of circuit cells in an LSI. The functions to be executed by the signal processing circuit 60 and the control circuit 70 may be implemented in software or may be implemented in hardware. The signal processing circuit 60 and the control circuit 70 may be implemented in a common hardware configuration.

The driver 80 is an element that changes the optical path length on the object side. The optical path length on the object side is the optical path length from the pulsed light source 10 to the detector 50 via the object 40. In the present embodiment, the driver 80 physically changes the position of the object 40. For example, the driver 80 is a movable stage that supports the object 40. However, the driver 80 is not limited to this. The driver 80 may be a belt conveyor, a robot arm, or the like. The type of the driver 80 is not particularly limited, provided that the driver 80 can change the physical position, posture, inclination, or the like of the object 40.

When the measurement device 100 configured as described above performs distance measurement of the object 40, the pulsed light source 10 outputs the light 10L. The output light 10L is split by the coupler 20 into the signal light 10Lt and the reference light 10Lr. The signal light 10Lt is emitted from the optical head 30 and incident on the object 40, and is reflected by the object 40. The reflected light 10R is incident on the optical head 31, and then travels toward the detector 50. The reference light 10Lr travels toward the detector 51.

The reflected light 10R and the reference light 10Lr are respectively converted into electric signals by the detectors 50 and 51. The signal processing circuit 60 processes the signal of the detector 50 as an object-side signal and the signal of the detector 51 as a reference-side signal by using time information or phase information, thereby calculating the distance from the measurement device 100 to a measurement point on the object 40.

In measurement at a certain measurement point, the control circuit 70 adjusts the optical path length on the object side by moving the driver 80 based on the electric signal output from the detector 50. To be specific, if the pulse position is in a range that may cause decrease of measurement accuracy, the control circuit 70 changes the position of the object 40 by controlling the driver 80 so that the pulse position moves out of the range. After changing the position of the object 40, measurement for the same measurement point is performed. Thus, the measurement device 100 can suppress decrease of measurement accuracy, and it is possible to measure the distance with high accuracy. Specific operation examples will be described below.

As in a second embodiment described below, the driver 80 may move the optical head 30 or 31 instead of the object 40. Also in this case, since the optical path length on the object side can be changed in the same way as in the case where the object 40 is moved, it is possible to measure the distance with high accuracy.

### Second Embodiment

Next, referring to FIG. 6B, the basic structure of a measurement device according to the second embodiment will be described.

The second embodiment differs from the first embodiment in that the light-emitting axis of light emitted to an object and the light-receiving axis of reflected light from the object are the same. That is, the measurement device according to the second embodiment is a device that performs coaxial distance measurement. The second embodiment differs from the first embodiment also in that the driver, which adjusts the optical path length, is provided on an optical head. Hereafter, differences from the first embodiment will be mainly described, and description of common features will be omitted or simplified.

FIG. 6B schematically illustrates a measurement device 110 according to the present embodiment. As illustrated in FIG. 6B, the measurement device 110 differs the measurement device 100 according to the first embodiment in that the measurement device 110 includes a circulator 90 instead of the optical head 31. In the measurement device 110, the driver 80 changes the position of the optical head 30.

The circulator 90 is an optical element that controls the direction of travel of light. Instead of the circulator 90, an element such as a beam splitter may be used, provided that the element can control the direction of travel of light.

When the measurement device 110 according to the present embodiment performs distance measurement of the object 40, the pulsed light source 10 outputs the light 10L. The output light 10L is split by the coupler 20 into the signal light 10Lt and the reference light 10Lr. The signal light 10Lt passes through the circulator 90, is emitted from the optical head 30 and incident on the object 40, and is reflected by the object 40. The reflected light 10R is incident on the optical head 30, and then is directed by the circulator 90 toward the detector 50. The reference light 10Lr travels toward the detector 51.

The reflected light 10R and the reference light 10Lr are respectively converted into electric signals by the detectors 50 and 51. As a method of calculating the distance, a method the same as that of the first embodiment can be used.

In this way, input and output of the signal light 10Lt and the reflected light 10R are performed via the same optical head 30. That is, the light-emitting axis of the signal light 10Lt to the object 40 and the light-receiving axis of the reflected light 10R from the object 40 are the same. Thus, even when the object 40 has a complex shape, it is possible to perform distance measurement with high accuracy. For example, when the object 40 has a structure like a deep hole, the measurement device 100 can receive light reflected at the bottom of the hole, because the light-emitting axis and the light-receiving axis are the same.

In the present embodiment, the driver 80 moves the position of the optical head 30. In the case where the position of the optical head 30 is moved, it is possible to change the optical path length on the object side in the same way as in the case where the position of the object 40 is moved. In the present embodiment, since the light-emitting axis and the light-receiving axis are the same, it is easy to control the amount of variation of the optical path length when the position of the optical head 30 is moved.

As in the first embodiment, the driver 80 may move the object 40 instead of the optical head 30. Also in this case, since the optical path length on the object side can be changed in the same way as in the case where the optical head 30 is moved, it is possible to measure the distance with high accuracy.

### Third Embodiment

Next, referring to FIG. 6C, the basic structure of a measurement device according to a third embodiment will be described.

The third embodiment differs from the second embodiment in that distance measurement is performed by using dual comb. Hereafter, differences from the first and second embodiments will be mainly described, and description of common features will be omitted or simplified.

When a plurality of pulsed light sources are used as in dual comb, as illustrated in FIG. 6C, both of light on the reference side and light on the object side of one of the pulsed light sources are not emitted to the object 40. Thus, it is possible to perform measurement with higher sensitivity.

FIG. 6C schematically illustrates a measurement device 120 according to the third embodiment. As illustrated in FIG. 6C, the measurement device 120 differs from the measurement device 110 according to the second embodiment in that the measurement device 120 includes optical comb lasers 11 and 12 instead of the pulsed light source 10. The measurement device 120 further includes couplers 21, 22, and 23.

As illustrated in FIG. 6C, the elements of the measurement device 120 are connected by optical fibers shown by broken lines or by cables shown by solid lines. For example, optical elements such as the couplers 20, 21, 22, and 23, the circulator 90, the optical head 30, and the detectors 50 and 51 are disposed on the path of optical fibers. The optical comb lasers 11 and 12 are connected to end portions of optical fibers.

The optical comb laser 11 is an example of a first light source that repeatedly emits first pulsed light. The optical comb laser 11 is an optical comb laser including a laser resonator. The optical comb laser 11 outputs light 11L as output light. The light 11L is, for example, optical comb laser light whose repetition frequency is fᵣₑₚ₁ and carrier envelope offset frequency is f_{CEO1} as illustrated in the upper half of FIG. 2.

The optical comb laser 12 is an example of a second light source that repeatedly emits second pulsed light. The optical comb laser 12 is an optical comb laser whose repetition frequency is different from that of the optical comb laser 11. The optical comb laser 12 outputs light 12L as output light. The light 12L is, for example, optical comb laser light whose repetition frequency is fᵣₑₚ₂ and carrier envelope offset frequency is f_{CEO2} as illustrated in the lower half of FIG. 2.

The couplers 20, 21, 22, and 23 are each an optical element that splits or combines light. The coupler 20 splits the light 11L into signal light 11Lt and reference light 11Lr. The coupler 21 splits the light 12L into signal light 12Lt and reference light 12Lr. The coupler 22 combines the reference light 11Lr and the reference light 12Lr. The coupler 23 combines reflected light 11R and the signal light 12Lt.

When the measurement device 120 according to the present embodiment performs distance measurement of the object 40, the optical comb lasers 11 and 12 respectively output the light 11L and the light 12L. The light 11L is split by the coupler 20 into the signal light 11Lt and the reference light 11Lr. The signal light 11Lt passes through the circulator 90, is emitted from the optical head 30 and incident on the object 40, and is reflected by the object 40. The reflected light 11R is incident on the optical head 30, and then is directed by the circulator 90 toward the coupler 23. The reference light 11Lr travels from the coupler 20 toward the coupler 22.

The light 12L is split by the coupler 21 into the signal light 12Lt and the reference light 12Lr. The reference light 12Lr is combined with the reference light 11Lr by the coupler 22 and travels toward the detector 50. The signal light 12Lt is combined with the reflected light 11R by the coupler 23 and travels toward the detector 51.

With the present embodiment, two optical comb laser beams interfere with each other in each of the detectors 50 and 51. To be specific, the detector 51 detects the reflected light 11R by causing the reflected light 11R to interfere with the signal light 12Lt, and outputs a first electric signal in accordance with the detection result. The first electric signal is, for example, a signal illustrated in the lower half of FIG. 3. The detector 50 detects the reference light 11Lr by causing the reference light 11Lr to interfere with the reference light 12Lr, and outputs a second electric signal in accordance with the detection result. The second electric signal is, for example, a signal illustrated in the upper half of FIG. 3. Based on the first electric signal and the second electric signal, the signal processing circuit 60 calculates the distance from the measurement device 120 to a measurement point on the object 40.

In the present embodiment, the driver 80 moves the position of the optical head 30. As in the second embodiment, it is possible to change the optical path length on the object side by moving the position of the optical head 30. As in the first embodiment, the driver 80 may move the object 40 instead of the optical head 30. In either case, since the optical path length on the object side can be changed, it is possible to measure the distance with high accuracy.

### Operation of Measurement Device (Measurement Method)

Next, the operations of the measurement devices 100, 110, and 120 according to the embodiments will be described. Hereafter, the operation of the measurement device 120, which uses dual comb, will be described as a representative. The operations of the measurement devices 100 and 110 are similar to that of the measurement device 120.

### First Example

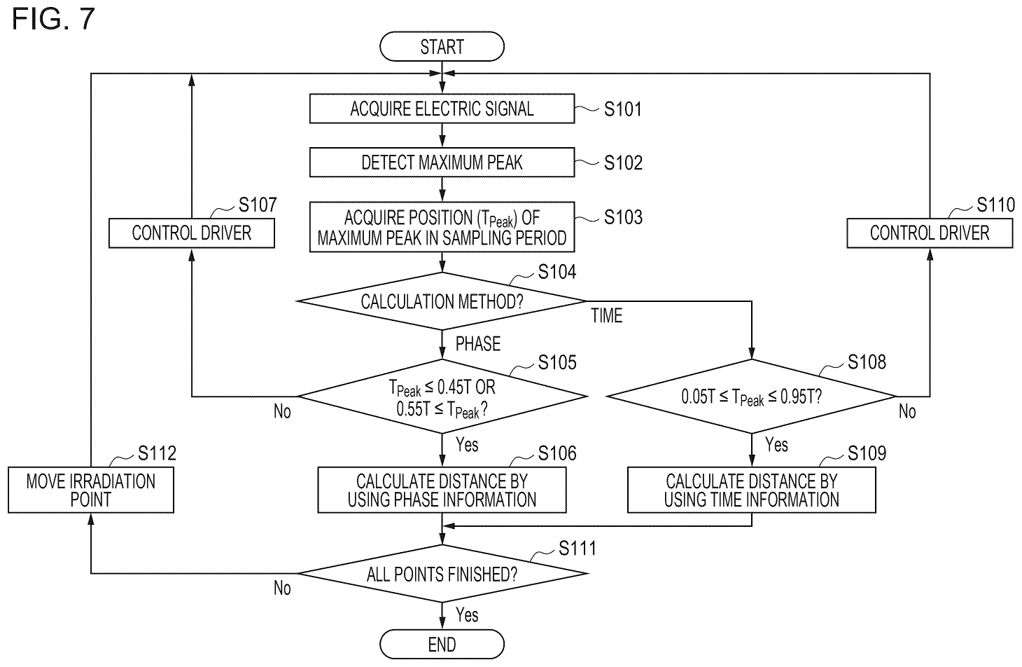

First, referring to FIG. 7, a first example of the operation of the measurement device 120 will be described.

FIG. 7 is a flowchart illustrating the first example of the operation of a measurement device according to each embodiment. The example illustrated in FIG. 7 is an operation example such that: whether or not it is necessary to change the optical path length is determined for each measurement, and, if it is determined that it is necessary to change the optical path length, the optical path length is changed to prevent decrease of measurement accuracy. The measurement device 120 starts the operation when receiving a start signal from an input unit (not shown) or the like.

### Step S101

As illustrated in FIG. 7, first, the signal processing circuit 60 acquires an electric signal detected by each of the detectors 50 and 51. The electric signal that the signal processing circuit 60 acquires includes, for example, signals of a plurality of pulsed light beams illustrated in FIG. 3. In other words, the signal processing circuit 60 acquires the time information of a pulse train.

### Step S102

Next, the signal processing circuit 60 or the control circuit 70 detects the maximum peak based on the time information of the pulse train. Here, the peak may be a peak in the obtained electric signal or may be a peak in an envelope of a pulse waveform.

### Step S103

Next, the control circuit 70 acquires the position (T_{Peak}) of the maximum peak in a sampling period. Here, since the start of the sampling period is 0 and the end of the sampling period is T, 0≤T_{Peak}≤T is satisfied.

### Step S104

Next, the control circuit 70 performs determination on a calculation method of distance conversion. To be specific, the control circuit 70 determines whether to use the phase information or to use the time information. Which information is to be used is preset. Alternatively, which information is to be used may be switched based on an instruction from a user. The determination in step S104 may be executed at the start of the operation of the measurement device 120, that is, before step S101.

When using the phase information (“phase” in S104), the measurement device 120 executes the processes indicated in steps S105 to S107, S111, and S112. When using the time information (“time” in S104), the measurement device 120 executes the processes indicated in steps S108 to S111.

### Step S105

When using the phase information (“phase” in S104), the control circuit 70 determines whether or not the position T_{Peak} of the maximum peak is in the vicinity of the center of the sampling period. To be specific, the control circuit 70 determines whether or not T_{Peak}≤0.45T or 0.55T≤T_{Peak} is satisfied.

### Step S106

If T_{Peak}≤0.45T or 0.55T≤T_{Peak} is satisfied (Yes in S105), the signal processing circuit 60 calculates the distance by using the phase information. To be specific, the signal processing circuit 60 Fourier-transforms each of the acquired second electric signal on the reference side and the acquired first electric signal on the object side. The signal processing circuit 60 converts the gradients of phase spectra obtained by Fourier transformation into distances, and, from the difference between these, calculates the distance from the measurement device 120 to the irradiation point.

### Step S107

If T_{Peak}≤0.45T or 0.55T≤T_{Peak} is not satisfied (No in S105), the control circuit 70 controls the driver 80 so that the position T_{Peak} of the maximum peak falls out of the range of greater than 0.45T and less than 0.55T, that is, so that T_{Peak}≤0.45T or 0.55T≤T_{Peak} is satisfied. Since the optical path length on the object side is changed by controlling the driver 80, the position T_{Peak} of the maximum peak changes. In this state, the process returns to step S101, and an electric signal for the same irradiation point is acquired. Subsequently, the measurement device 120 executes the process after step S102.

### Step S108

When using the time information (“time” in S104), the control circuit 70 determines whether or not the position T_{Peak} of the maximum peak is in the vicinity of an end of the sampling period. To be specific, the control circuit 70 determines whether or not 0.05T≤T_{Peak}≤0.95T is satisfied.

### Step S109

If 0.05T≤T_{Peak}≤0.95T is satisfied (Yes in S108), the signal processing circuit 60 calculates the distance by using the time information. To be specific, the signal processing circuit 60 converts the positions of the maximum peaks of the acquired second electric signal on the reference side and the acquired first electric signal on the object side into distances, and, from the difference between these, calculates the distance from the measurement device 120 to the irradiation point.

### Step S110

If 0.05T≤T_{Peak}≤0.95T is not satisfied (No in S108), the control circuit 70 controls the driver 80 so that the position T_{Peak} of the maximum peak falls out of both of the range of less than 0.05T and the range of greater than 0.95T, that is, so that 0.05T≤T_{Peak}≤0.95T is satisfied. Since the optical path length on the object side is changed by controlling the driver 80, the position T_{Peak} of the maximum peak changes. In this state, the process returns to step S101, and an electric signal for the same irradiation point is acquired. Subsequently, the measurement device 120 executes the process after step S102.

### Step S111

After the distance from the measurement device 120 to the irradiation point has been calculated in step S106 or S109, the control circuit 70 determines whether or not measurement at all points has finished. Here, all points are, for example, all measurement points on the surface of the object 40 at which measurement is to be performed, that is, all irradiation points to be irradiated with the signal light 11Lt. If measurement at all points has finished (Yes in S111), the operation of distance measurement by the measurement device 120 finishes. If measurement at all points has not finished (No in S111), the measurement device 120 executes the process indicated in step S112.

### Step S112

If measurement at all points has not finished, the measurement device 120 moves an irradiation point on the object 40. For example, a movable stage (not shown) that supports the object 40 is used to move the irradiation point on the object 40. Another method may be used, provided that it is possible to change the irradiation point. After the irradiation point has been moved, the process returns to step S101, and an electric signal at the new irradiation point is acquired. Subsequently, the measurement device 120 executes the process after step S102.

As described above, in the example illustrated in FIG. 7, the control circuit 70 determines whether or not it is necessary to change the optical path length for each measurement, that is, for each irradiation point of the signal light 11Lt (step S105 or S108). If the control circuit 70 determines that it is necessary to change the optical path length, the control circuit 70 varies the optical path length by controlling the driver 80 (step S107 or S110). Thus, it is possible to increase the measurement accuracy at each irradiation point.

### Second Example

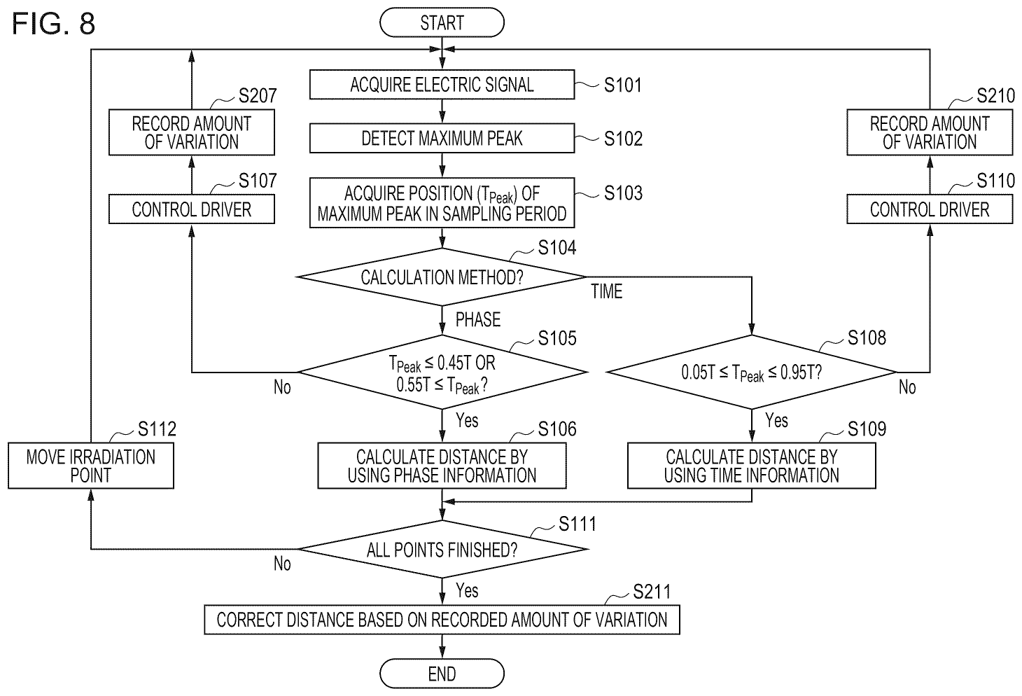

Next, referring to FIG. 8, a second example of the operation of the measurement device 120 will be described.

FIG. 8 is a flowchart illustrating the second example of the operation of a measurement device according to each embodiment. The example illustrated in FIG. 8 differs from the first example in that a process of correcting the distance is performed based on the amount of variation of the optical path length. Hereafter, differences from the first example will be mainly described, and description of common features will be omitted or simplified.

As illustrated in FIG. 8, since each of the processes of steps S101, S102, S103, S104, S105, S106, S107, S108, S109, S110, S111, and S112 is similar to a corresponding one of the processes according to the first example illustrated in FIG. 7, descriptions of these steps will be omitted.

### Step S207

The process indicated in step S207 is executed after the process indicated in step S107. To be specific, the control circuit 70 records the amount of variation of the optical path length. The amount of variation may be the amount of variation of the optical path length on the object side itself, or may be the movement amount of the driver 80 or the amount of physical movement of the optical head 30 or the object 40.

The control circuit 70 stores the amount of variation in a memory incorporated in the control circuit 70 or the signal processing circuit 60. Provided that the amount of variation can be recorded, the amount of variation may be recorded in another memory included in the measurement device 120, or may be recorded in a memory included in a device other than the measurement device 120.

### Step S210

The process indicated in step S210 is executed after the process indicated in step S110. To be specific, the control circuit 70 records the amount of variation of the optical path length. The specific process is the same as that of step S207.

### Step S211

In the example illustrated in FIG. 8, after measurement at all points has finished (Yes in S111), the signal processing circuit 60 retrieves the amount of variation stored in the memory, and corrects the distance calculated in step S106 or S109. Correction of the distance is performed for one or more irradiation points at which the driver 80 is controlled in step S107 or S110.

With the measurement device 120, since the optical path length is varied by controlling the driver 80, the amount of variation of the optical path length is added to the calculated distance as an offset. For example, when the surface shape of the object 40 is to be measured, it may not be possible to accurately measure the surface shape since an obtained result includes several portions where the offset is superposed.

To address this problem, as illustrated in FIG. 8, when the driver 80 varies the optical path length, the signal processing circuit 60 corrects the distance based on the amount of variation of the optical path length. Thus, measurement results for all points on the object 40 are appropriately corrected, and, for example, it is possible to measure the surface shape of the object 40 with high accuracy.

In the example illustrated in FIG. 8, correction is performed after measurement at all points has finished. However, this is not a limitation. The signal processing circuit 60 may correct a calculated distance each time the distance is calculated, that is, at a timing immediately after step S106 or S109.

### Third Example

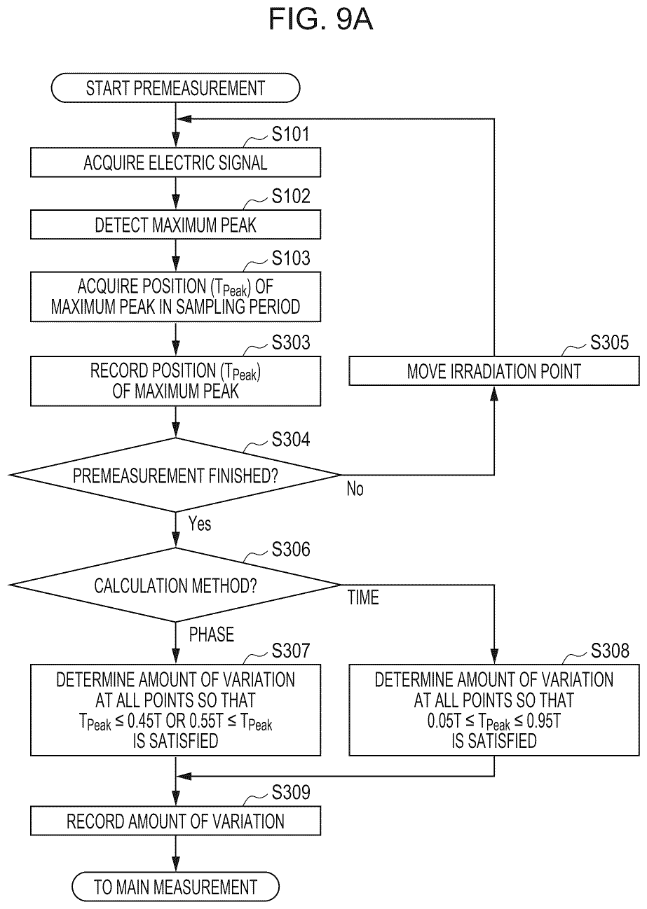

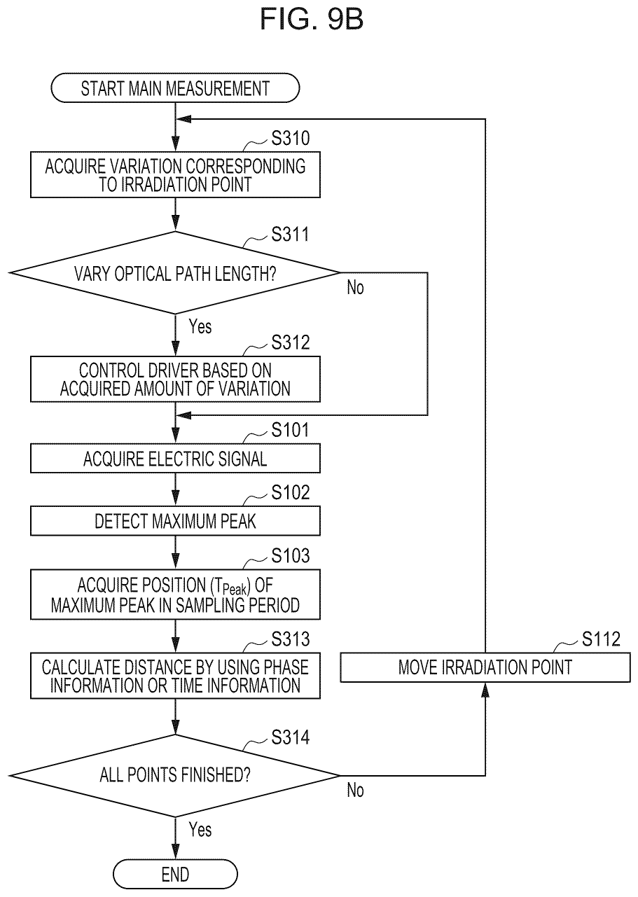

Next, referring to FIGS. 9A and 9B, a third example of the operation of the measurement device 120 will be described.

FIG. 9A is a flowchart illustrating an example of premeasurement in the third example of a measurement device according to each embodiment. FIG. 9B is a flowchart illustrating an example of main measurement in the third example of a measurement device according to each embodiment. In the third example, the measurement device 120 performs the main measurement illustrated in FIG. 9B after performing the premeasurement illustrated in FIG. 9A.

First, referring to FIG. 9A, an operation related to the premeasurement will be described. Hereafter, differences from the first example will be mainly described, and description of common features will be omitted or simplified. As illustrated in FIG. 9A, since each of the processes of steps S101, S102, and S103 is similar to a corresponding one of the processes according to the first example illustrated in FIG. 7, descriptions of these steps will be omitted.

### Step S303

The process indicated in step S303 is executed after the process indicated in step S103. To be specific, the signal processing circuit 60 records the acquired position (T_{Peak}) of the maximum peak in a memory.

### Step S304

Next, the control circuit 70 determines whether or not to finish the premeasurement. The premeasurement is performed, for example, for all points on the object 40. All points are, for example, all measurement points on the surface of the object 40 at which measurement is to be performed, that is, all irradiation points to be irradiated with the signal light 11Lt. In the premeasurement, measurement may be performed for only some of all points.

### Step S305

If the premeasurement is not to be finished (No in S304), that is, if measurement for all points has not finished, the measurement device 120 moves the irradiation point on the object 40. To move the irradiation point on the object 40, for example, a movable stage (not shown) that supports the object 40 is used. Another method may be used, provided that it is possible to change the irradiation point. After the irradiation point has been moved, the process returns to step S101, and an electric signal at the new irradiation point is acquired. Subsequently, the measurement device 120 executes the process after step S102.

### Step S306

If the premeasurement has finished (Yes in S304), the control circuit 70 determines the calculation method of distance conversion. To be specific, the control circuit 70 determines whether to use the phase information or to use the time information. The determination in step S306 is the same as the determination in step S104 illustrated in FIG. 7 or 8. The determination in step S306 may be executed at the start of the operation of the measurement device 120, that is, before step S101.

### Step S307

When using the phase information (“phase” in S306), the control circuit 70 determines the amount of variation of the optical path length at all points based on the recorded position T_{Peak} of the maximum peak. To be specific, the control circuit 70 determines the amount of variation of the optical path length at all points so that T_{Peak}≤0.45T or 0.55T≤T_{Peak} is satisfied. That is, the control circuit 70 determines the amount of variation of the optical path length so that the position T_{Peak} of the maximum peak at each irradiation point becomes farther from the center of the sampling period. For example, if the recorded position T_{Peak} of the maximum peak is in the range of greater than 0.45T and less than 0.55T, the control circuit 70 determines the amount of variation for causing T_{Peak} to fall out of this range. The control circuit 70 regards the amount of variation as 0 if the recorded position T_{Peak} of the maximum peak satisfies T_{Peak}≤0.45T or 0.55T≤T_{Peak}.

### Step S308

When using the time information (“time” in S306), the control circuit 70 determines the amount of variation of the optical path length at all points based on the recorded position T_{Peak} of the maximum peak. To be specific, the control circuit 70 determines the amount of variation of the optical path length at all points so that 0.05T≤T_{Peak}≤0.95T is satisfied. That is, the control circuit 70 determines the amount of variation of the optical path length so that the position T_{Peak} of the maximum peak at each irradiation point becomes closer to the center of the sampling period. For example, if the recorded position T_{Peak} of the maximum peak is in the range of less than 0.05T or greater than 0.95T, the control circuit 70 determines the amount of variation for causing T_{Peak} to fall out of both of these range. The control circuit 70 regards the amount of variation as 0 if the recorded position T_{Peak} of the maximum peak satisfies 0.05T≤T_{Peak}≤0.95T.

### Step S309

After determining the amount of variation in step S307 or S308, the control circuit 70 records the determined amount of variation in a memory. At this time, the control circuit 70 may record, as the amount of variation, the amount of driving of the driver 80, to be specific, the amount of physical movement of the optical head 30 or the object 40. By recording the amount of driving of the driver 80, it is possible to rapidly control the driver 80 at a corresponding irradiation point in a short period.

As described above, according to the present example, the amount of variation of the optical path length when measuring each irradiation point is determined by performing the premeasurement. Therefore, in the main measurement, the control circuit 70 can control the driver 80 based on the determined amount of variation.

Hereafter, referring to FIG. 9B, an operation related to the main measurement will be described. Hereafter, differences from the first example will be mainly described, and description of common features will be omitted or simplified. As illustrated in FIG. 9B, since each of the processes of S101, S102, S103, and S112 is similar to a corresponding one of the processes according to the first example illustrated in FIG. 7, descriptions of these steps will be omitted.

### Step S310

When the main measurement is started, first, the control circuit 70 acquires an amount of variation corresponding to an irradiation point. To be specific, the control circuit 70 retrieves the amount of variation recorded in the premeasurement from the memory.

### Step S311

Next, the control circuit 70 determines whether or not it is necessary to vary the optical path length. To be specific, if the retrieved amount of variation is 0, the control circuit 70 determines that it is not necessary to vary the optical path length. Also if the amount of variation corresponding to the irradiation point is not recorded in the memory, the control circuit 70 determines that it is not necessary to vary the optical path length. If it is not necessary to vary the optical path length (No in S311), the measurement device 120 executes the process after step S101.

### Step S312

If it is necessary to vary the optical path length (Yes in S311), the control circuit 70 controls the driver 80 based on the retrieved amount of variation. The amount of variation has a value that has been determined based on the premeasurement so that the position T_{Peak} of the maximum peak is positioned in a range such that the measurement accuracy does not easily decrease. Therefore, since the position T_{Peak} of the maximum peak emerges in an appropriate range in the main measurement by controlling the driver 80 based on the amount of variation, it is possible to perform measurement with high accuracy. After controlling the driver 80, the measurement device 120 executes the process after step S101.

### Step S313

The process indicated in step S313 is executed after the process indicated in step S103. To be specific, the signal processing circuit 60 calculates the distance from the measurement device 120 to an irradiation point by using the phase information or the time information. At this time, the signal processing circuit 60 uses information used in the premeasurement. That is, if the phase information has been used in the premeasurement, the signal processing circuit 60 uses the phase information also in the main measurement. If the time information has been used in the premeasurement, the signal processing circuit 60 uses the time information also in the main measurement. The specific method of calculating the distance is the same as the process indicated in step S106 or S109 of FIG. 7.

### Step S314

After the distance from the measurement device 120 to the irradiation point has been calculated in step S313, the control circuit 70 determines whether or not measurement at all points has finished. Here, all points are, for example, all measurement points on the surface of the object 40 on which measurement is to be performed, that is, all irradiation points to be irradiated with the signal light 11Lt. If measurement at all points has finished (Yes in S314), the operation of distance measurement by the measurement device 120 finishes. If measurement at all points has not finished (No in S314), the measurement device 120 executes the process indicated in step S112.

As described above, in the example illustrated in FIGS. 9A and 9B, the control circuit 70 performs premeasurement of measuring all points on the object 40 once and then determines the amount of variation of the optical path length based on the measurement result. The control circuit 70 performs main measurement of remeasuring all points on the object 40 again so that the measurement accuracy may not decrease while changing the optical path length based on the determined amount of variation.

Thus, by acquiring the amount of variation of the optical path length at all points beforehand, it is possible to suppress occurrence of a large change in the amount of variation. For example, it is possible to avoid a situation such that: if the optical path length is varied at a certain measurement point, and, since the amount of variation is too large or too small, it becomes necessary to vary the optical path length again at the next measurement point. Thus, it is possible to increase the accuracy of distance measurement while suppressing the amount of variation of the optical path length.

### Fourth Example

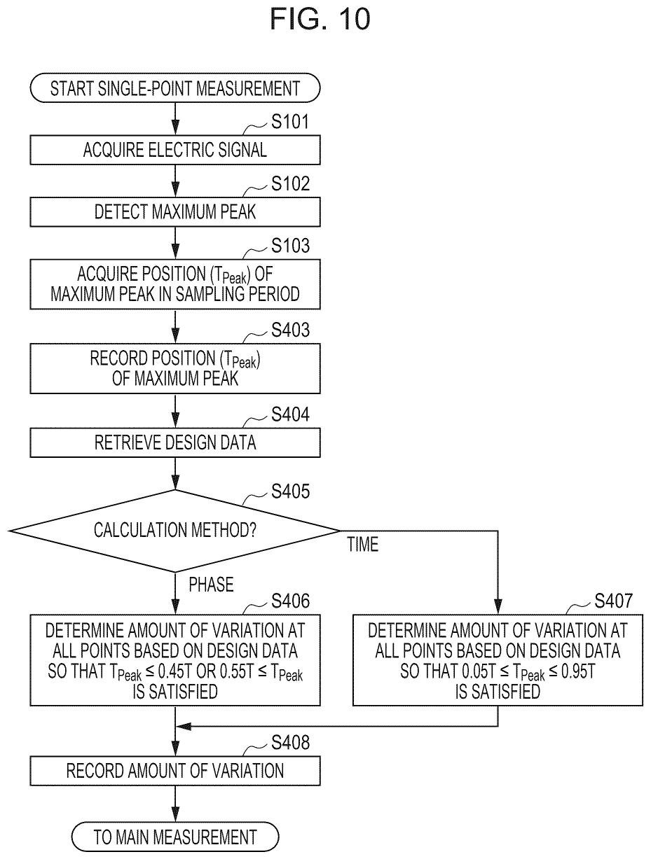

Next, referring to FIG. 10, a fourth example of the operation of the measurement device 120 will be described.

FIG. 10 is a flowchart illustrating an example of single-point measurement in the fourth example of a measurement device according to each embodiment. The single-point measurement illustrated in FIG. 10 corresponds the premeasurement of the third example. The measurement device 120 performs the main measurement illustrated in FIG. 9B after performing the single-point measurement illustrated in FIG. 10. In the fourth example, the amount of variation of the optical path length at each irradiation point is determined by performing the single-point measurement illustrated in FIG. 10.

Hereafter, an operation related to the single-point measurement will be described. Differences from the first example will be mainly described, and description of common features will be omitted or simplified. As illustrated in FIG. 10, since each of the processes of S101, S102, and S103 is similar to a corresponding one of the processes according to the first example illustrated in FIG. 7, descriptions of these steps will be omitted.

### Step S403

The process indicated in step S403 is executed after the process indicated in step S103. To be specific, the signal processing circuit 60 records the acquired maximum peak position (T_{Peak}) in a memory.

### Step S404

Next, the control circuit 70 retrieves design data of the object 40. The design data of the object 40 is, for example, 3D-CAD (Computer Aided Design) data in the case of distance measurement. For example, if the object 40 is an industrial product and the measurement device 120 is used for inspection of the object 40, design data used for manufacturing the object 40 is stored in a memory. The control circuit 70 acquires the design data by retrieving the design data from the memory.

### Step S405

Next, the control circuit 70 determines the calculation method of distance conversion. To be specific, the control circuit 70 determines whether to use the phase information or to use the time information. The determination in step S405 is the same as the determination in step S104 illustrated in FIG. 7 or 8. The determination in step S405 may be executed at the start of the operation of the measurement device 120, that is, before step S101.

### Step S406

When using the phase information (“phase” in S406), the control circuit 70 determines the amount of variation of the optical path length at all points based on the recorded position T_{Peak} of the maximum peak. To be specific, the control circuit 70 determines the amount of variation of the optical path length at all points so that T_{Peak}≤0.45T or 0.55T≤T_{Peak} is satisfied. That is, the control circuit 70 determines the amount of variation of the optical path length so that the position T_{Peak} of the maximum peak at each irradiation point becomes farther from the center of the sampling period. By referring to the design data, the control circuit 70 can estimate the position T_{Peak} of the maximum peak for all of the remaining unmeasured points from the position T_{Peak} of the maximum peak for the single measured point. Therefore, by using the estimation result, the control circuit 70 can determine the amount of variation of the optical path length at all points. Specific determination method is similar to that of step S307 illustrated in FIG. 9A.

### Step S407

When using the time information (“time” in S405), the control circuit 70 determines the amount of variation of the optical path length at all points based on the recorded position T_{Peak} of the maximum peak and the design data. To be specific, the control circuit 70 determines the amount of variation of the optical path length at all points so that 0.05T≤T_{Peak}≤0.95T is satisfied. That is, the control circuit 70 determines the amount of variation of the optical path length so that the position T_{Peak} of the maximum peak at each irradiation point becomes closer to the center of the sampling period. As in step S406, by referring to the design data, the control circuit 70 can estimate the position T_{Peak} of the maximum peak for all of the remaining unmeasured points from the position T_{Peak} of the maximum peak for one measured point. Therefore, by using the estimation result, the control circuit 70 can determine the amount of variation of the optical path length at all points. Specific determination method is similar to that of step S308 illustrated in FIG. 9A.

### Step S408

After determining the amount of variation in step S406 or S407, the control circuit 70 records the determined amount of variation in a memory. At this time, the control circuit 70 may record, as the amount of variation, the amount of driving of the driver 80, to be specific, the amount of physical movement of the optical head 30 or the object 40. By recording the amount of driving of the driver 80, it is possible to rapidly control the driver 80 at a corresponding irradiation point in a short period.

As described above, according to the fourth example, measurement of measuring a single point on the object 40 is performed, and, based on the measurement result and the design data of the object 40, the amount of variation of the optical path length when measuring each irradiation point is determined. Therefore, in the main measurement, the control circuit 70 can control the driver 80 based on the determined amount of variation. It is possible to shorten the time required for measurement compared with a case where the premeasurement is performed.

### OTHER EMBODIMENTS

Heretofore, measurement devices according one or more aspects have been described based on embodiments. However, the present disclosure is not limited to these embodiments. Within the gist of the present disclosure, modifications of the embodiments that a person having ordinary skill in the art can conceive and embodiments that are constructed by combining elements of different embodiments are also included in the scope of the present disclosure.

For example, the pulsed light source 10 need not be an optical comb laser. That is, the pulsed light source 10 need not include a resonator, and may be, for example, an LD (Laser Diode) or an LED (Light Emitting Diode) that repeatedly emits pulsed light.

For example, an example in which the driver 80 varies the optical path length by moving the object 40 or the optical head 30 has been described. However, the driver 80 is not limited to this. For example, the driver 80 may vary the optical path length by using expansion and contraction of an optical fiber. For example, the driver 80 may be a temperature-adjusting element that heats or cools an optical fiber. As the temperature-adjusting element, a Peltier element, a blower, a heater, or the like can be used.

An example in which an end of a sampling period is in the range of less than 0.05T or greater than 0.95T has been described. However, the range is not limited to this. For example, the upper limit value of an initial portion of a sampling period may be in the range of greater than 0 and less than or equal to 0.10T. The upper limit value of a terminal portion of a sampling period may be in the range of greater than or equal to 0.90T and less than T.

An example in which the central range of a sampling period is the range of greater than 0.45T and less than 0.55T has been described. However, the range is not limited to this. For example, the lower limit value of the central range may be greater than or equal to 0.40T and less than 0.50T. The upper limit value the central range may be greater than 0.50T and less than or equal to 0.60T. For example, the upper limit value and the lower limit value may be changed in accordance with the length of the sampling period.

For example, in the embodiments described above, a process to be executed by a specific processor may be executed by another processor. The order of a plurality of processes may be changed, or a plurality of processes may be parallelly executed.

For example, the process described in the embodiments may be realized by centralized processing using a single device (system) or may be realized by distributed processing using a plurality of devices. The program may be executed by a single processor or a plurality of processors. That is, centralized processing may be performed, or distributed processing may be performed.

In the embodiments described above, all or some of the elements, such as the signal processing circuit 60 and the control circuit 70, may be implemented in dedicated hardware or may be implemented by executing a software program suitable for each element. Each element may be implemented by a program executer, such as a CPU (Central Processing Unit) or a processor, that retrieves and executes a software program stored in an HDD (Hard Disk Drive), a semiconductor memory, or the like.

The elements, such as the signal processing circuit 60 and the control circuit 70, may be implemented in one or more electronic circuits. The one or more electronic circuits each may be a general-purpose circuit or a dedicated circuit.

The one or more electronic circuits may include, for example, a semiconductor device, an IC, an LSI, or the like. The IC or LSI may be integrated in one chip or may be integrated in a plurality of chips. Here, a device called an IC or an LSI may be called by another name depending on the degree of integration, and may called a system LSI, a VLSI (Very Large Scale Integration) or an ULSI (Ultra Large Scale Integration). An FPGA, which is an LSI that is programmed after being manufactured, can be used for the same purpose.

General or specific embodiments the present disclosure may be implemented in a system, a device, a method, an integrated circuit, or a computer program. Alternatively, general or specific embodiments may be implemented as a non-transitory computer-readable storage medium, such as a CD-ROM, an HDD, or a semiconductor memory storing the computer program. General or specific embodiments or may be implemented as any selective combination of a system, a method, an integrated circuit, a computer program, and a non-transitory storage medium.

Various modifications, replacements, additions, and omissions can be made on each of the embodiments within the scope of the claims and the equivalents thereof.

The present disclosure can be used for, for example, distance measurement and displacement measurement. For example, a measurement device and a measurement method according to the present disclosure can be used in a displacement gauge, a shape inspection device, and the like.

What is claimed is:

1. A measurement device comprising:
a first light source that repeatedly emits first pulsed light;
a first photodetector that detects reflected pulsed light that is generated when the first pulsed light is reflected by an object and that outputs a first electric signal in accordance with a detection result of the reflected pulsed light;
a signal processing circuit that calculates a distance from the measurement device to the object based on the first electric signal in a sampling period; and
a control circuit that controls a driver that varies an optical path length from the first light source to the first photodetector via the object, wherein
the control circuit changes a position of a peak of the reflected pulsed light in the first electric signal in the sampling period by controlling the driver, and
the sampling period is synchronized with a timing at which the first light source emits the first pulsed light.

2. The measurement device according to claim 1,
wherein the first light source is an optical comb laser.

3. The measurement device according to claim 2, further comprising:
a second light source that is an optical comb laser and that repeatedly emits second pulsed light; and
a second photodetector that detects a part of the first pulsed light by causing the part of the first pulsed light to interfere with a first portion of the second pulsed light and that outputs a second electric signal in accordance with a detection result of the part of the first pulsed light, wherein
a repetition frequency of the second light source differs from a repetition frequency of the first light source,
the first photodetector detects the reflected pulsed light by causing the reflected pulsed light to interfere with a second portion of the second pulsed light, the second portion being different from the first portion, and
the signal processing circuit calculates the distance based on the first electric signal and the second electric signal.

4. The measurement device according to claim 1, wherein
the signal processing circuit calculates the distance based on a time waveform corresponding to the reflected pulsed light in the sampling period, and
the control circuit controls the driver so that the position of the peak becomes closer to a center of the sampling period.

5. The measurement device according to claim 1, wherein
the signal processing circuit calculates the distance based on a phase spectrum corresponding to the reflected pulsed light in the sampling period, and
the control circuit controls the driver so that the position of the peak becomes farther from a center of the sampling period.

6. The measurement device according to claim 1, wherein,
each time an irradiation point moves, the control circuit determines whether the optical path length needs to be changed, the irradiation point being a position on the object irradiated with the first pulsed light, and
if the control circuit determines that the optical path length needs to be changed, the control circuit varies the optical path length by controlling the driver.

7. The measurement device according to claim 1,
wherein, when the driver varies the optical path length, the signal processing circuit corrects the distance based on an amount of variation of the optical path length.

8. The measurement device according to claim 7, wherein
the signal processing circuit records the amount of variation of the optical path length when the driver varies the optical path length for each of a plurality of irradiation points, the plurality of irradiation points being positions on the object irradiated with the first pulsed light, and
the signal processing circuit corrects the distance for each of the plurality of irradiation points based on the amount of variation recorded by the signal processing circuit.

9. The measurement device according to claim 1, wherein
the measurement device performs main measurement of measuring the distance after performing premeasurement,
in the premeasurement, the control circuit determines an amount of variation of the optical path length at each of a plurality of irradiation points based on the first electric signal that is obtained for each of the plurality of irradiation points, the plurality of irradiation points being positions on the object irradiated with the first pulsed light, and
in the main measurement, the control circuit controls the driver in accordance with the amount of variation at each of the plurality of irradiation points.

10. The measurement device according to claim 1, wherein
the control circuit determines an amount of variation of the optical path length at each of a plurality of irradiation points including at least one irradiation point based on the first electric signal obtained for the at least one irradiation point and information about a shape of the object, the at least one irradiation point being a position on the object irradiated with the first pulsed light, and
the control circuit controls the driver in accordance with the amount of variation at each of the plurality of irradiation points.

11. The measurement device according to claim 1, further comprising the driver.

12. A measurement method comprising:
causing a light source to repeatedly emit pulsed light;
causing a photodetector to detect reflected pulsed light that is generated when the pulsed light is reflected by an object and to output an electric signal in accordance with a detection result of the reflected pulsed light;
causing a signal processing circuit to calculate a distance from the light source to the object based on the electric signal in a sampling period; and
controlling a driver that varies an optical path length from the light source to the photodetector via the object, wherein,
in the controlling, a position of a peak of the reflected pulsed light in the electric signal in the sampling period is changed by controlling the driver, and
the sampling period is synchronized with a timing at which the light source emits the pulsed light.
